(19) United States
(12) Patent Application Publication
(10) Pub. No.: US 2025/0390503 A1
(43) Pub. Date: Dec. 25, 2025

(54) SYSTEMS AND METHODS FOR CONNECTIVITY BETWEEN CONTENT MANAGEMENT SYSTEMS AND MLR, STAKEHOLDER AND PLATFORM INTEGRATION

(71) Applicant: Kevin John Greiner, Houston, TX (US)

(72) Inventor: Kevin John Greiner, Houston, TX (US)

(21) Appl. No.: 18/221,116

(22) Filed: Jul. 12, 2023

Related U.S. Application Data
(60) Provisional application No. 63/389,123, filed on Jul. 14, 2022.

(51) Int. Cl. G06F 16/25; G06F 16/21

(52) U.S. Cl. CPC G06F 16/258; G06F 16/219; G06F 16/252

(57) ABSTRACT

Systems and methods of transferring data back and forth between a content management system and an MLR platform is disclosed. The system includes a means for selecting a best node packager for a current payload and a means for converting the payload into a document stored in a vault. The information is then updated in a content management system.

### CROSS-REFERENCE TO RELATED APPLICATIONS

The present application claims priority to U.S. Provisional Application No. 63/389,123 filed Jul. 14, 2022, titled “SYSTEMS AND METHODS FOR CONNECTIVITY BETWEEN CONTENT MANAGEMENT SYSTEMS AND MLR, STAKEHOLDER AND PLATFORM INTEGRATION” which is hereby incorporated by reference in its entirety.

### TECHNICAL FIELD

Embodiments of the invention relate to systems and methods for bi-directional connectivity between content management systems (e.g., Adobe™ CMS) and MLR (medical, legal, and regulatory), Stakeholder, and Platform Integration (e.g., Veeva Vault™) that enable seamless syncing of assets and metadata between the systems.

### BACKGROUND

Medical, legal, and regulatory systems frequently. Many companies whose focus are medical products have adopted Veeva Vault for its MLR functionality and Adobe Experience Manager (AEM) for their public facing web sites. XpConnect provides for transferring both simple, and composite, assets between these two platforms using a number of distinct transformations. For example, 1) binary assets, with their supporting metadata, maybe copied in both directions between AEM and Veeva. 2) web pages may be packaged as a zip file (similar to the ‘Save As . . . ’ functionality in most browsers) and supplemented by a PDF containing images of the web page as it appears in a web browser which is then transferred to Veeva where the MLR process may be used to approve publishing the web page to the public web site. 3) web pages may be transformed to use a Veeva proprietary API then packaged for display as slides within a presentation that may be downloaded, and viewed, using Veeva's platform to support marketing at facilities whose security prevents access to the internet.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The example embodiments provided herein relate to and disclose systems and methods for saving web pages within a unified platform, such as Adobe Experience Manager (AEM). These webpages can be saved in a standardized file format, for example as a PDF file. This can be accomplished through installable software in the form of a package that is integrated within AEM.

The embodiments include systems and methods of transferring data back and forth between a content management system and an MLR platform is disclosed. The system includes a means for selecting a best node packager for a current payload and a means for converting the payload into a document stored in a vault. The information is then updated in a content management system.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of the computer system, according to some embodiments;

FIG. 2 illustrates a system architecture diagram, according to some embodiments;

FIG. 3 illustrates a block diagram of the application program and computing system, according to some embodiments;

FIG. 4 illustrates an architecture and connection diagram, according to some embodiments;

FIG. 5 illustrates an architecture diagram, according to some embodiments;

FIG. 6 illustrates a content management system to MLR platform transfer diagram, according to some embodiments;

FIG. 7 illustrates a MLR platform to content management system transfer diagram, according to some embodiments;

FIG. 8A-8B show unannotated and annotated workflow diagrams illustrating how a document is sent from a content management platform to a MLR platform, according to some embodiments;

FIG. 9 shows a diagram illustrating configuration setting properties for a process step, according to some embodiments;

FIG. 10 shows a diagram illustrating a website wireframe within a CMS platform that includes a hierarchy of configuration settings, according to some embodiments;

FIG. 11 shows a diagram illustrating a Mime type determination process, according to some embodiments;

FIG. 12 shows a diagram illustrating a CMS to MLR platform upload process, according to some embodiments; and

FIG. 13 shows a diagram illustrating a CMS to MLR document transformation process, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The systems and methods described herein can enable seamless integration between content management systems (e.g., herein, Adobe Experience Manager (AEM) will provide an example, but others are also contemplated) and MLR platforms (e.g., Veeva Vault will provide an example but others are also contemplated). With these systems and methods, compliant use of assets within AEM becomes automatic: AEM authors can rest assured they are always leveraging the latest approved content from Veeva Vault, without leaving AEM. In addition, these systems and methods automate the MLR submission process. AEM content creators can leverage these systems and methods' workflows to automatically submit composite assets for MLR review in Veeva Vault directly from AEM. These systems and methods manage and preserve metadata between both systems throughout the transfer process.

The systems and methods herein can be a platform and a management system. With these systems and methods, companies improve speed to market through faster MLR submissions, drive quality through compliant asset use, and reduce cost through the reduction of manual effort.

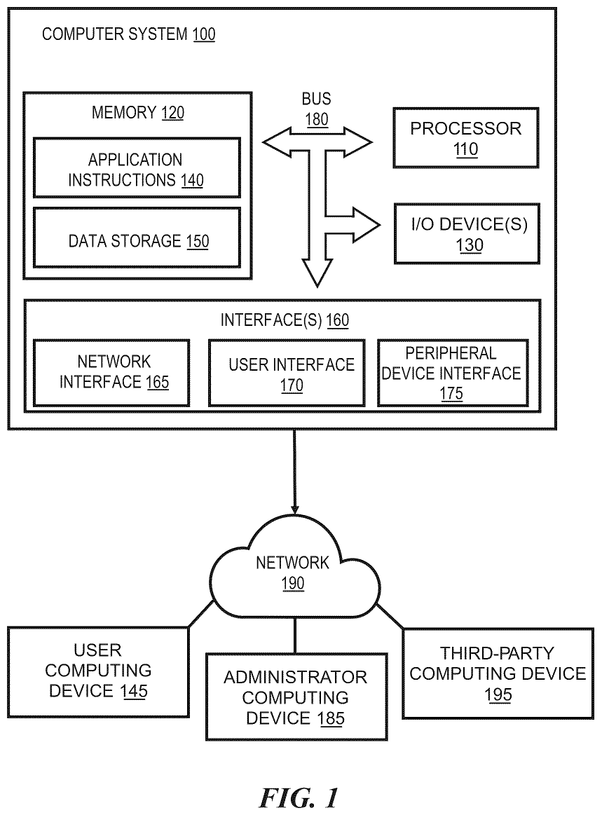

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

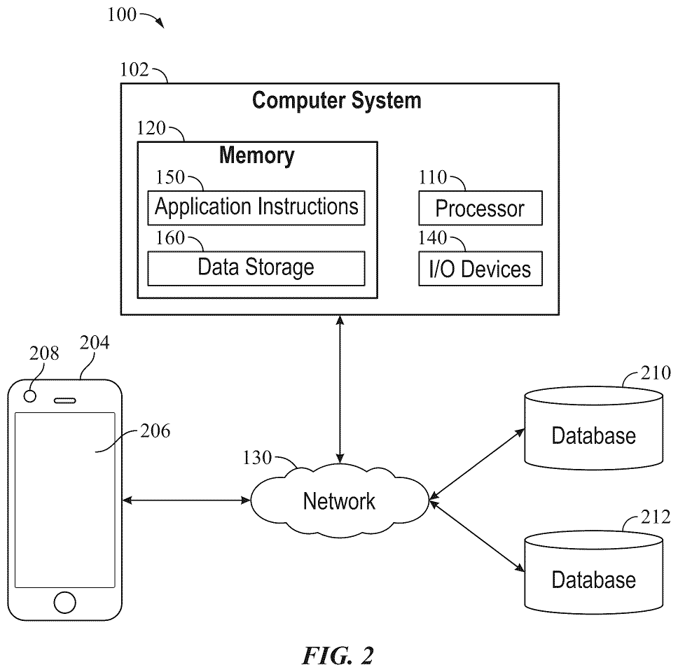

FIG. 2 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface. In many embodiments, computer system 102 can be a server that is fully automated or partially automated and may operate with minimal or no interaction or human input during processes described herein. As such, many embodiments of the processes described herein can be fully automated or partially automated.

As shown in the example embodiment, a mobile computing device 204 can also be communicatively coupled with and exchange data with network 130. Those in the art will understand that mobile computing device 204 can include some or all of the same or similar components as computer system 102, coupled to constitute an operable device. Mobile computing device 104 can be a personal digital assistant (PDA), smartphone, tablet computer, laptop, wearable computing device such as a smartwatch or smart glasses, or other device that includes one or more user interface 206, such as a touchscreen and/or audio input/output and/or other display and user input components. Mobile computing device 204 can also include one or more image capturing or reading component 208 (e.g., a digital camera, scanner, or others) and associated structures and elements operatively coupled to at least one processor and memory of the mobile computing device.

Also shown in FIG. 2 are one or more database(s) 210,212. These databases can be locally stored in memory or remotely stored in memory that is accessible by computer system 102 via network 130 and may be proprietary, public, or some combination thereof. These databases can also be third-party or system databases in some embodiments and may have one of any manner of structures, privacy measures, and other features and elements.

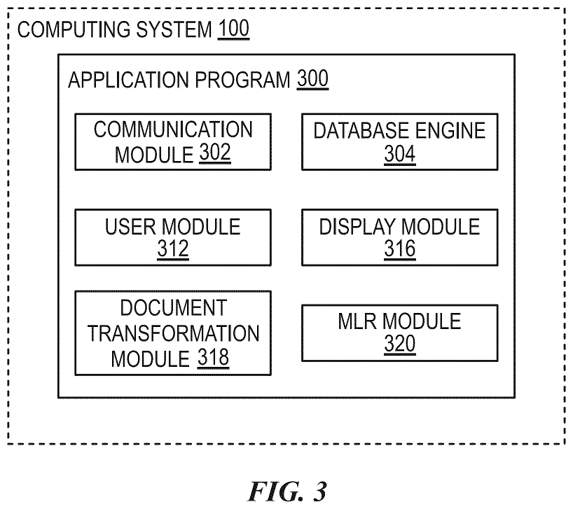

FIG. 3 illustrates an example computer architecture for the application program 300 operated via the computer system 100. The computer system 100 comprises several modules and engines configured to execute the functionalities of the application program 300, and a database engine 304 configured to facilitate how data is stored and managed in one or more databases. In particular, FIG. 2 is a block diagram showing the modules and engines needed to perform specific tasks within the application program 200.

Referring to FIG. 3, the computing system 100 operating the application program 200 comprises one or more modules having the necessary routines and data structures for performing specific tasks, and one or more engines configured to determine how the platform manages and manipulates data. In some embodiments, the application program 300 comprises one or more of a communication module 302, a database engine 304, a user module 312, a display module 216, a document transformation module 318, and an MLR module 320.

In some embodiments, the communication module 302 is configured for receiving, processing, and transmitting a user command and/or one or more data streams. In such embodiments, the communication module 302 performs communication functions between various devices, including the user computing device 145, the administrator computing device 185, and a third-party computing device 195. In some embodiments, the communication module 302 is configured to allow one or more users of the system, including a third-party, to communicate with one another. In some embodiments, the communications module 302 is configured to maintain one or more communication sessions with one or more servers, the administrative computing device 185, and/or one or more third-party computing device(s) 195.

In some embodiments, a database engine 304 is configured to facilitate the storage, management, and retrieval of data to and from one or more storage mediums, such as the one or more internal databases described herein. In some embodiments, the database engine 304 is coupled to an external storage system. In some embodiments, the database engine 304 is configured to apply changes to one or more databases. In some embodiments, the database engine 304 comprises a search engine component for searching through thousands of data sources stored in different locations.

In some embodiments, the user module 312 facilitates the creation of a user account for the application system. The user module 312 may allow the user to create a user profile which includes user information, user preferences, and user-associated information.

In some embodiments, the display module 316 is configured to display one or more graphic user interfaces, including, e.g., one or more user interfaces, one or more consumer interfaces, one or more video presenter interfaces, etc. In some embodiments, the display module 316 is configured to temporarily generate and display various pieces of information in response to one or more commands or operations. The various pieces of information or data generated and displayed may be transiently generated and displayed, and the displayed content in the display module 316 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged by the user.

In some embodiments, the document transformation module 318 is configured to transform the CMS document into an MLR document. Once the CMS document is recognized the MLR platform API, utilizing the MLR module 320, acquires information related to the type of document to be created. Using the document type and metadata from the CMS platform, the MLR module 320 and document transformation module 318 may create the MLR document using the content and metadata. MLR data may be generated via the MLR module 320 using the renditions of the new document. The MLR module 320 may also generate relationships between the new document and previously existing documents.

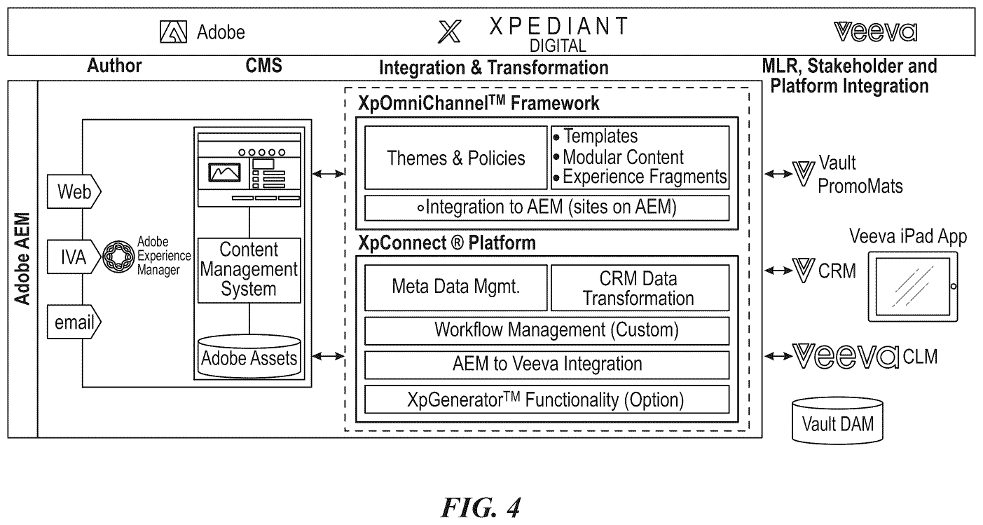

FIG. 4 illustrates an architecture and connection diagram, according to some embodiments. In some embodiments the systems and methods herein can be loosely coupled OSGI bundles within AEM as an author instance. Assets and metadata stored in the MLR platform can be retrieved by the system using the MLR platform's API. Initial migrations may cause limits to be reached but subsequently are not an issue. Limits can be suspended temporarily in some instances. Service components can be used when uploading assets to the MLR platform to handle the asset type. This can be extensible to support the needs of organizations with unique asset types.

The systems and methods herein can use AEM's asset manager to physically move assets from Veeva. However, the CDN option of the MLR platform can allow for references to the asset's CDN URL to be made in AEM through the use of the systems and methods herein without copying the asset into AEM.

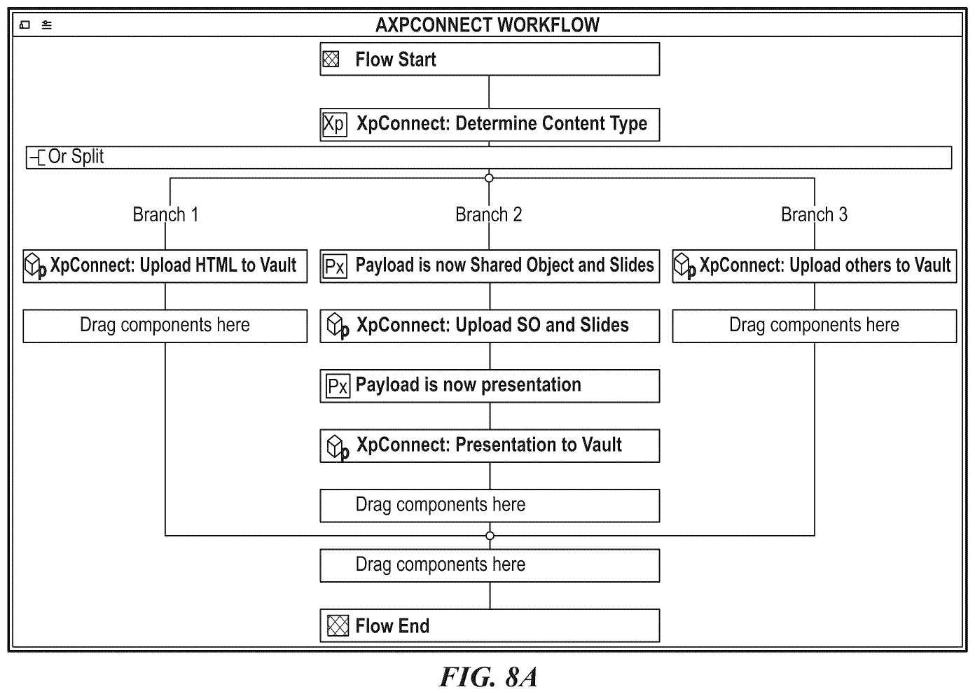

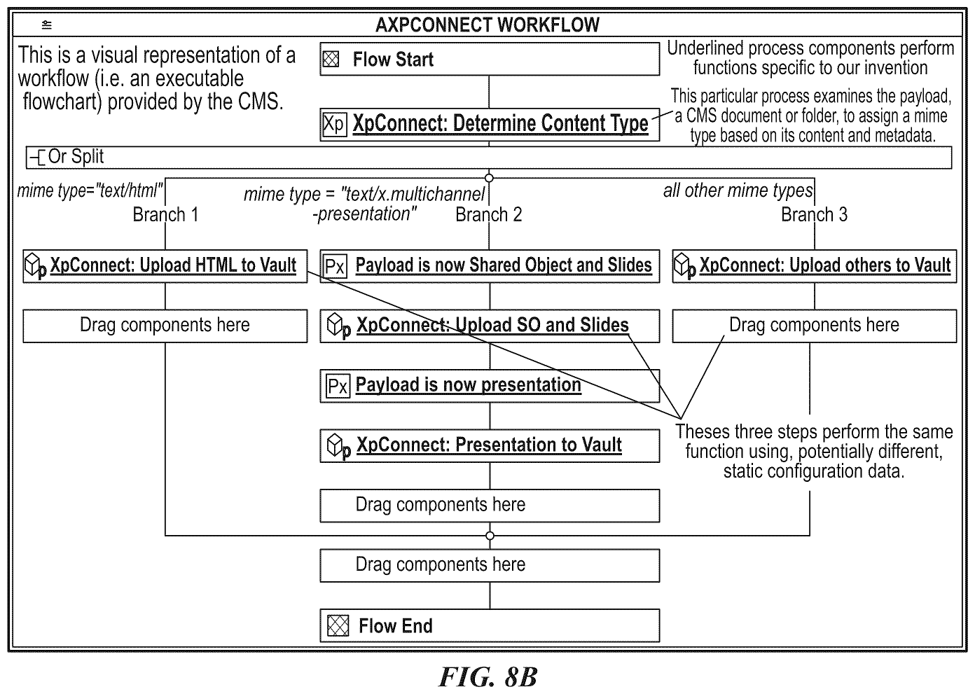

An important step in uploading an AEM document to a Veeva document can be providing all of the required document fields (metadata). To provide flexibility, the systems and methods herein can look for metadata in at least one of the following places: 1) Properties, such as veeva: Country, that are co-located with the AEM document; 2) The documentDefaultsByDocType configuration in the system's hierarchy of configurations (e.g., see FIG. 8 and associated description for an example of a hierarchy of configurations settings). This configuration provides metadata specific to a Veeva Document Type; 3) The documentSettingsByMimeType configuration in the system's hierarchy of configurations. This configuration provides metadata specific to the Mime Type of the content in the AEM document; 4) Document type and lifecycle properties specified in the workflow configuration; or others Headless Chrome: The system platform can generate PDF's using headless Chrome. This may need to be installed on the AEM server as part of initial setup. The system platform may also use Chrome located on a remote compute system in which case the system platform will provide that Chrome with secure credentials for accessing the content being converted to PDF. Embodiments are not limited to Chrome and can be applied with various web browsers including those from browserstack.com and others.

Bi-Directional Connectivity: The system platform can be bi-directional: Veeva assets can be sent to AEM, and AEM assets can be sent to Veeva (including corresponding metadata). The system can preserve the “system of truth” for a piece of content.

Workflows: The system platform can be used as part of a multi-step AEM workflow to upload the resulting output to Veeva Vault.

Asset Expiration: If an asset expires in Veeva, for example, the system platform can automatically remove that asset from AEM. The removal occurs only within the AEM Author instance where the system platform is installed, so there are no broken references on a production site (with the exception of expired CDN assets, which are removed from all instances that reference it).

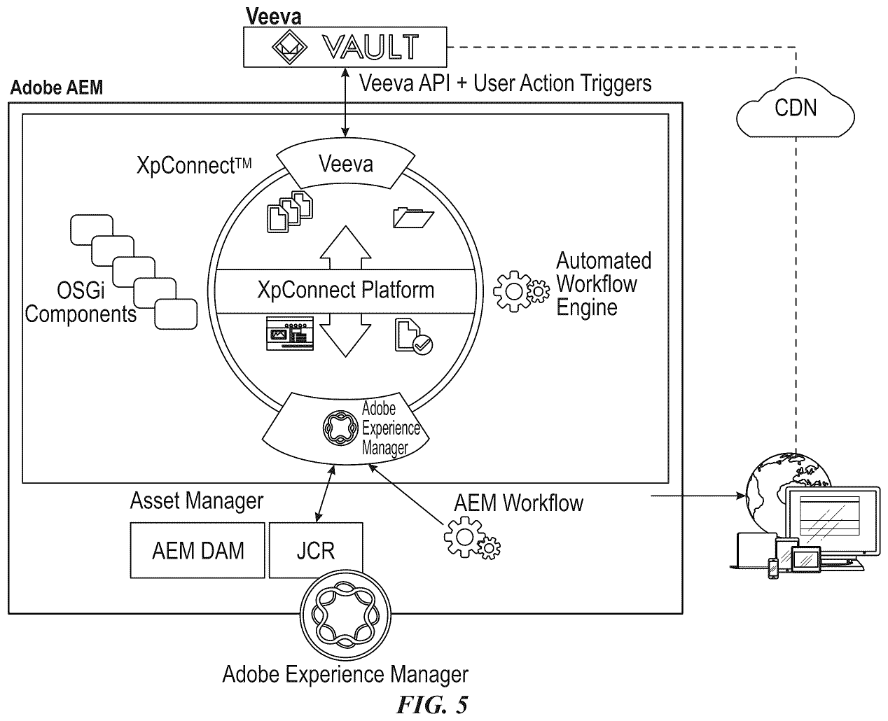

FIG. 5 illustrates an architecture diagram, according to some embodiments.

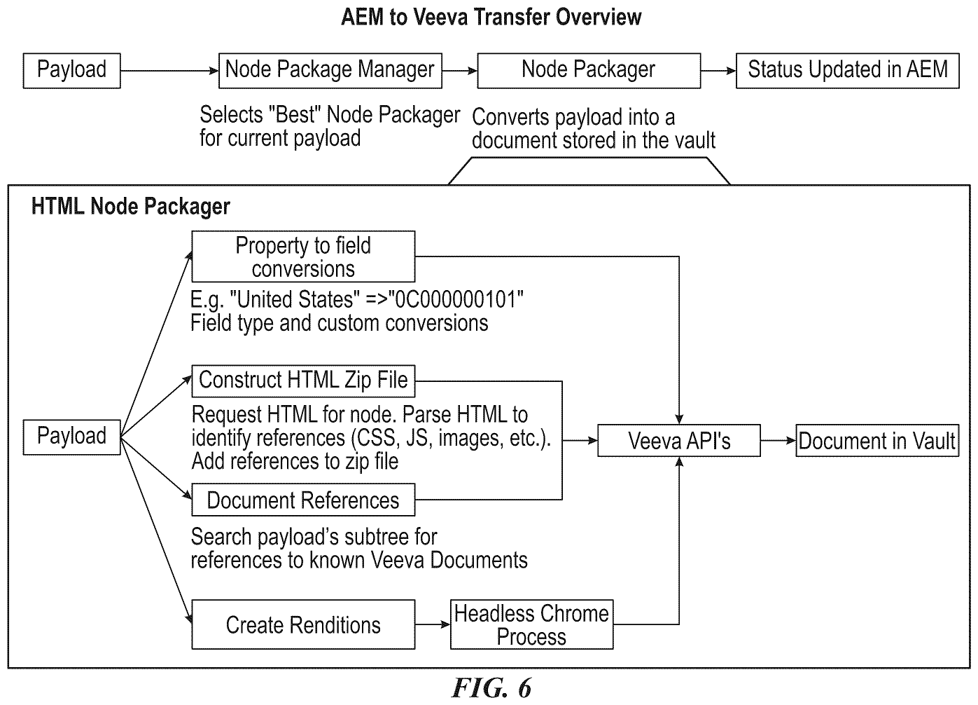

FIG. 6 illustrates content management system to MLR platform transfer diagram, according to some embodiments.

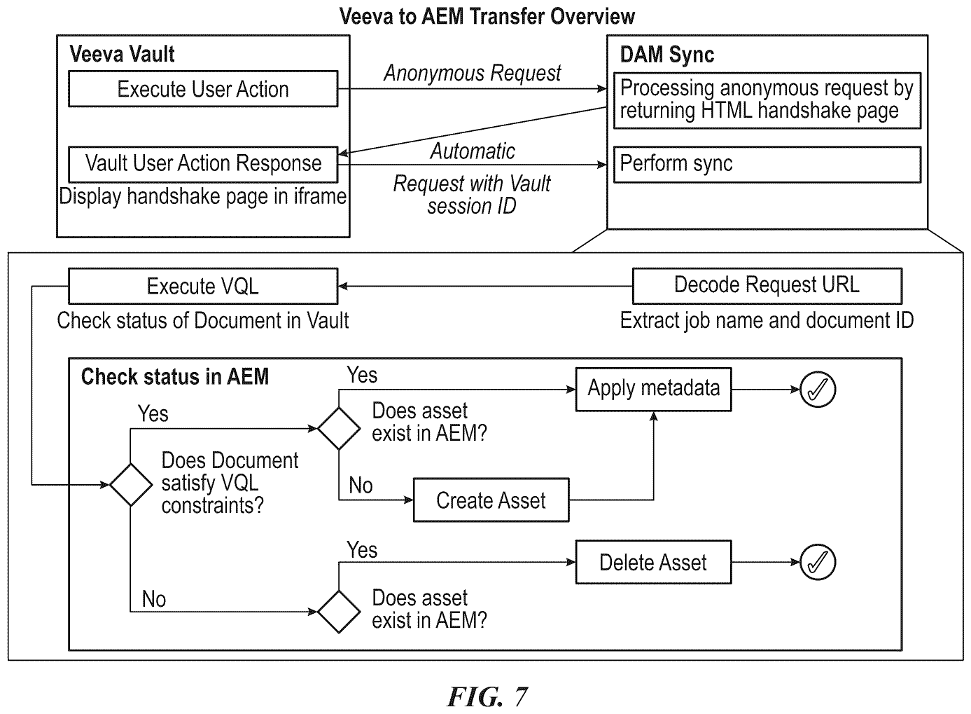

FIG. 7 illustrates MLR platform to content management system transfer diagram, according to some embodiments.

FIG. 8A-8B show unannotated and annotated workflow diagrams illustrating how a document is sent from a content management platform to a MLR platform, according to some embodiments. As shown, an executable flowchart provided by the CMS can include various process components that perform functions for systems and methods disclosed herein. The three initial steps shown perform similar or the same function using static configuration data that is potentially different, in some embodiments.

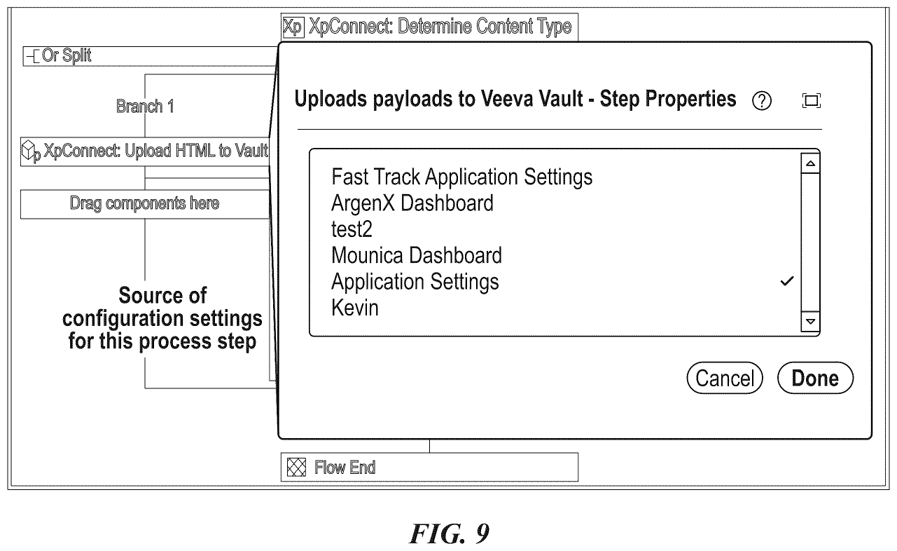

FIG. 9 shows a diagram illustrating configuration setting properties for a process step, according to some embodiments. Here, configuration settings can be applied from a menu or other means by an administrator.

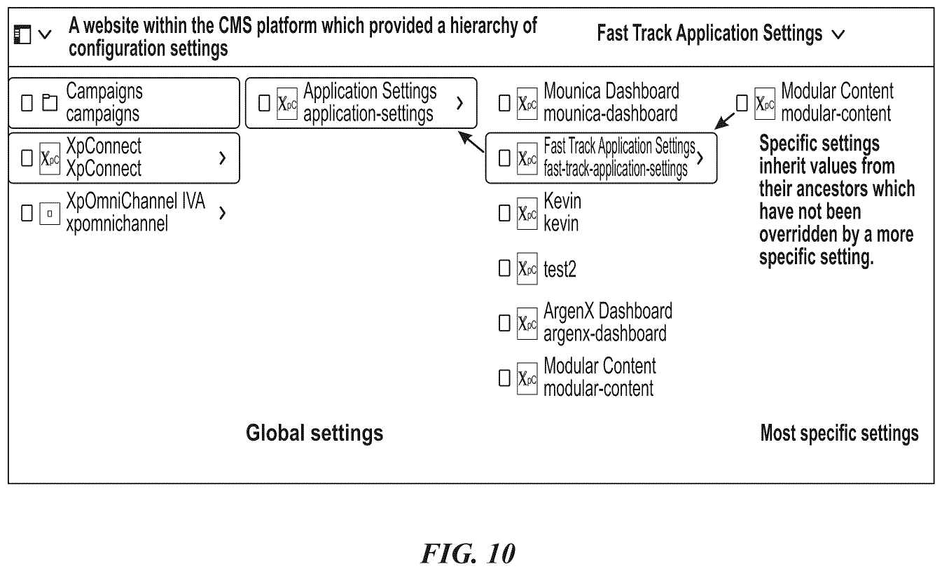

FIG. 10 shows a diagram illustrating a website wireframe within a CMS platform that includes a hierarchy of configuration settings, according to some embodiments. As shown, global settings can be further refined into different layers of more specific settings. Specific settings can inherit values from ancestors that have not been overridden by more specific settings.

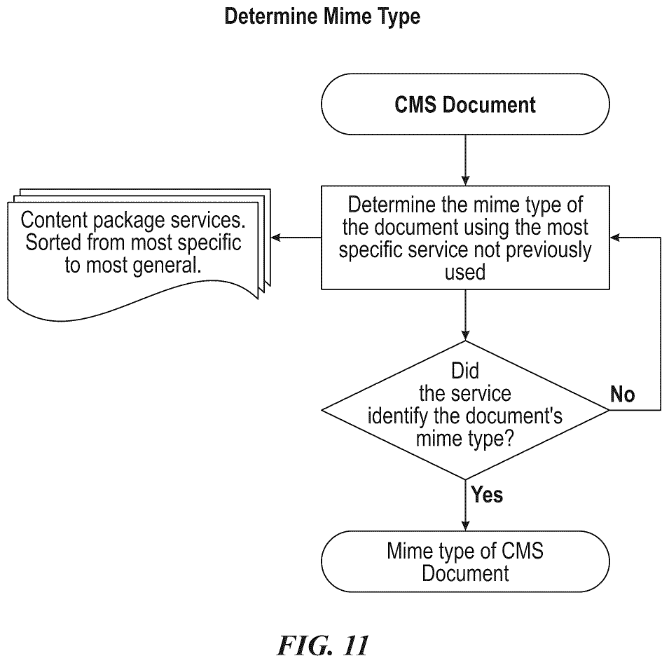

FIG. 11 shows a diagram illustrating a Mime type determination process, according to some embodiments. As shown, a CMS documents may first undergo a determination of the mime type of the documents using a most specific service that has not been previously used. Content package services can be sorted from most specific to most general. Upon determination, if the service does not identify the mime's type, the determination can be repeated. If the mime type was identified, then it can be used or applied by the system.

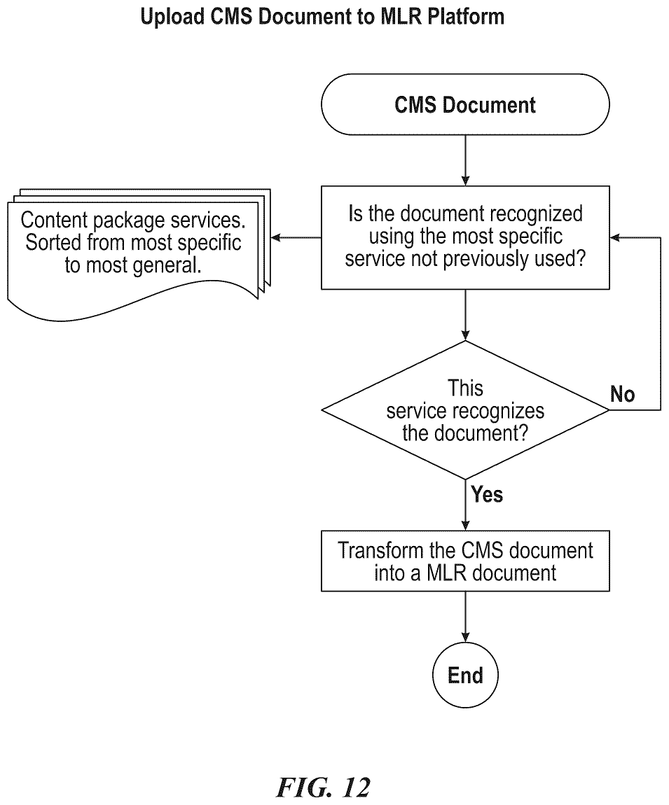

FIG. 12 shows a diagram illustrating a CMS to MLR platform upload process, according to some embodiments. Here, if the service recognizes the document, then it can transform the document into a MLR document.

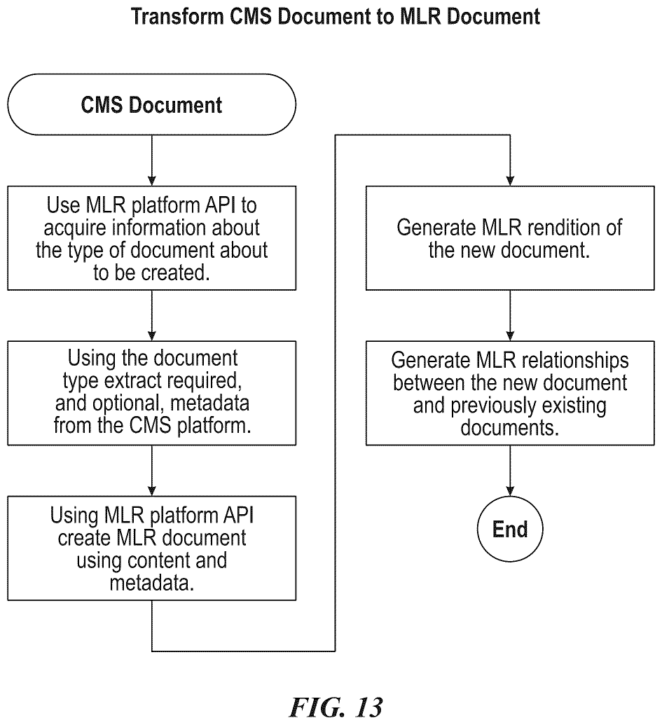

FIG. 13 shows a diagram illustrating a CMS to MLR document transformation process, according to some embodiments. As shown, first a MLR platform API can be used to acquire information about the type of document about to be created. This can be accomplished document type extract required and optional metadata from the CMS platform. Next the MLR platform API can create a MLR document using content and metadata. Next, MLR renditions of the new document can be generated. Finally, MLR relationships can be generated between the new document and previously existing documents.

Configurations & Services: The system platform can be configured to support multiple Vaults, AEM instances, asset types, workflows, and many other combinations. The items below cover the core or out-of-the-box configuration and services.

Known Veeva Vaults: Factory Service responsible for managing the objects that describe a Vault's configuration to the system. May have multiple.

Veeva Vault AEM Path String Absolute path to this vault's description in JCR.

DAM Synchronization: The system executes a process in AEM to synchronize from Veeva to AEM. This process will query both AEM and Veeva to get the current state of the document in each environment, then perform the necessary actions to bring the document(s) in AEM up to date. This process may be initiated via a user action in the Veeva Vault, or any standalone application (e.g., chron job, AEM workflow) capable of sending an HTTP request.

Synchronization Session Caching—All of Veeva Vault's API results are cached during a synchronization session to improve performance and minimize the number of API calls.

Multichannel Services handling multichannel slides, objects, and other IVA-specific components. May have multiple configurations.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A system for transferring documents between a content management system to an MLR platform, comprising:
a device comprising:
a processor; and
a non-transitory, computer readable memory storing instructions that, when executed by the processor upon a user selection, cause the device to:
select a best node packager for a current payload;
convert the payload into a document stored in a vault; and
update a status in the content management system.

2. The system of claim 1, further comprising a document transformation module to transform a CMS document to an MLR document.

3. The system of claim 2, wherein the document transformation module determines a document type to enable extraction of the CMS document.

4. The system of claim 1, wherein the MLR document is stored, via a database engine, in at least one database.

5. The system of claim 1, wherein the content management system is in operable communication with the at least one database to permit the user to view the MLR document via a computing device.

6. The system of claim 1, further comprising an MLR module to create the MLR document via a plurality of content and a plurality of metadata.

7. The system of claim 6, wherein the MLR module generates one or more renditions of the MLR document.

8. The system of claim 7, wherein an MLR platform API acquires CMS document information to determines the document type.

9. A system for transferring documents between a content management system to an MLR platform, the system comprising:
at least one user computing device in operable connection with a user network;
an application server in operable communication with the user network, the application server configured to host an application program for transferring documents between a content management system to an MLR platform, the application program having a user interface module for providing access to the application program via the at least one user computing device;
a processor and a non-transitory, computer readable memory storing instructions that, when executed by the processor upon a user selection, cause the device to:
select a best node packager for a current payload;
convert the payload into a document stored in a vault; and
update a status in the content management system.

10. The system of claim 9, further comprising a document transformation module to transform a CMS document to an MLR document.

11. The system of claim 10, wherein the document transformation module determines a document type to enable extraction of the CMS document.

12. The system of claim 11, wherein the MLR document is stored, via a database engine, in at least one database.

13. The system of claim 12, wherein the content management system is in operable communication with the at least one database to permit the user to view the MLR document via a computing device.

14. The system of claim 13, further comprising an MLR module to create the MLR document via a plurality of content and a plurality of metadata.

15. The system of claim 14, wherein the MLR module generates one or more renditions of the MLR document.

16. The system of claim 15, wherein an MLR platform API acquires CMS document information to determines the document type.
